(19) United States
(12) Patent Application Publication
(10) Pub. No.: US 2019/0247782 A1
(43) Pub. Date: Aug. 15, 2019

(54) APPARATUS, METHODS AND SYSTEMS FOR MULTI-STAGE SCRUBBING OF GAS MIXTURES

(71) Applicant: enVerid Systems, Inc., Westwood, MA (US)

(72) Inventors: Udi MEIRAV, Newton, MA (US); Sharon PERL-OLSHVANG, Pardes Hanna-Karkur (IL)

(73) Assignee: enVerid Systems, Inc., Westwood, MA (US)

(21) Appl. No.: 16/310,712

(22) PCT Filed: Jun. 19, 2017
(86) PCT No.: PCT/US17/38199

§ 371 Date: Dec. 17, 2018

Related U.S. Application Data
(60) Provisional application No. 62/507,088, filed on May 16, 2017.
(60) Provisional application No. 62/452,382, filed on Jan. 31, 2017.
(60) Provisional application No. 62/351,293, filed on Jun. 17, 2016.

(51) Int. Cl. B01D 53/04; H01M 8/0668

(52) U.S. Cl. CPC B01D 53/0462; H01M 8/0668; B01D 2257/504; B01D 2259/4068; B01D 2259/40056; B01D 2259/40096; B01D 2259/4508; B01D 2258/0208

(57) ABSTRACT

In some embodiments, a multistage scrubber that includes a plurality of stages, each stage comprising one or more scrubbing modules having adsorbents configured to adsorb and remove molecules from a flowing mixture of gas traversing the multi-stage scrubber is disclosed. The sorbents may be used in repeatable adsorption-regeneration swing cycles including concentration swing adsorption (CSA) cycle, temperature swing adsorption (TSA) cycle and pressure swing adsorption (PSA) cycle.

### CROSS REFERENCE TO RELATED APPLICATIONS

This application is a non-provisional of and claims priority under 35 U.S.C. § 119 to U.S. Provisional Patent Application No. 62/507,088, filed May 16, 2017, entitled “Multi Stage Carbon Dioxide Scrubber”; U.S. Provisional Patent Application No. 62/452,382, filed Jan. 31, 2017, entitled “Multi Stage Carbon Dioxide Scrubber”; and U.S. Provisional Patent Application No. 62/351,293, filed Jun. 17, 2016, entitled “Multi Stage Carbon Dioxide Scrubber”. Each of the above applications is expressly incorporated by reference herein in its entirety.

### FIELD OF THE DISCLOSURE

The present disclosure relates to methods, devices and systems for scrubbing or removing unwanted molecules from a fluid, and more particularly, to multi-stage scrubbers configured to achieve high throughput while reducing the concentration of the unwanted molecules in the fluid at high efficiency.

### BACKGROUND

A variety of sorbents have been used in repeatable adsorption-regeneration swing cycles for scrubbing certain types of molecules (the adsorbate) from gas mixtures. For example, sorbents containing zeolites, amines, silica, alumina and the like have been used to scrub CO₂ from an airflow. The swing cycles can be concentration swing adsorption (CSA) cycle, temperature swing adsorption (TSA) cycle or pressure swing adsorption (PSA) cycle. However, reducing the CO₂ concentration level to sufficiently low amount while achieving high throughput have been a challenge, in particular when regeneration is performed with ordinary air which can contain native CO₂ concentration in excess of 400 parts per million (ppm).

### SUMMARY OF SOME OF THE EMBODIMENTS

Some embodiments of the current disclosure include a multi-stage system for reducing a concentration of at least a first gas entrained in a gas mixture, the system comprising a plurality of staged treatment systems (STSs) including at least one concentration swing adsorption (CSA)-based stage treatment system and at least one temperature swing adsorption (TSA)-based stage treatment system, wherein: each STS comprises one or more treatment assemblies each including a regenerable adsorption material; the STSs are configured to successively treat a gas mixture having at least a first gas entrained therein, one after the other, such that, after the gas mixture is treated by the CSA-based STS it is subsequently received and treated by the TSA-based STS, the regenerable adsorption material for the CSA-based STS is configured to regenerate by a first regeneration airflow via a CSA cycle, and the regenerable adsorption material for the TSA-based STS is configured to regenerate by a second regeneration airflow via a TSA cycle.

In some embodiments, the one or more treatment assemblies include at least two treatment assemblies. Further, the system may comprise a primary inlet manifold configured to receive the gas mixture into the system. In some embodiments the system may also comprise a primary outlet manifold configured to release the gas mixture after treatment by all of the plurality of STSs. In some embodiments, the one or more of the plurality of STS include between about 2-10 treatment assemblies.

In some embodiments, each STS includes at least two treatment assemblies connected in parallel. In some embodiments, each STS includes at least two treatment assemblies connected in parallel, one of the at least two treatment assemblies configured to be in a regeneration phase or an adsorption phase when the other treatment assembly is in an adsorption phase or a regeneration phase, respectively. In some embodiments, regeneration of the regenerable adsorption material for the CSA-based STS is performed at a temperature that is no greater than about 10° C. above an adsorption temperature during adsorption of the first gas by the regenerable adsorption material for the CSA-based STS. In some embodiments, regeneration of the regenerable adsorption material for the CSA-based STS is performed at a temperature that is no greater than about 20° C. above an adsorption temperature during adsorption of the first gas by the regenerable adsorption material for the CSA-based STS.

In some embodiments, regeneration of the regenerable adsorption material for the TSA-based STS is performed at a temperature that is at least about 10° C. above an adsorption temperature during adsorption of the first gas by the regenerable adsorption material for the TSA-based STS. In some embodiments, regeneration of the regenerable adsorption material for the TSA-based STS is performed at a temperature that is at least about 20° C. above an adsorption temperature during adsorption of the first gas by the regenerable adsorption material for the TSA-based STS.

In some embodiments, the first gas entrained in the gas mixture is CO₂. In some embodiments, the first gas entrained in the gas mixture is one of ammonia, hydrogen, water, carbon monoxide and urea. In some embodiments, a concentration of the first gas in the gas mixture prior to treatment by any one of the plurality of STS is greater than about 5%, about 10%, about 15%, about 20%, about 25%, including values therebetween. In some embodiments, a first STS of the plurality of STS to treat the gas mixture removes between about 30% to about 90%, about 50% to about 90%, about 50% to about 95%, about 50% to about 99%, about 75% to about 90%, about 75% to about 99%, including values and subrange therebetween, of a concentration of the first gas entrained in the gas mixture. In some embodiments, a concentration of the first gas entrained in the gas mixture upon exiting the multi-stage system is less than about 150 parts per million (ppm), 100 ppm, 50 ppm, 10 ppm, including values and subrange therebetween.

In some embodiments, one or both of the regenerable adsorption material for the CSA-based STS and the regenerable adsorption material for the TSA-stage treatment system are solid-supported amine. In some embodiments, the TSA-based STS is configured to treat the gas mixture last prior to the gas mixture exiting the system without being treated any further by any other treatment assembly of the plurality of STS. In some embodiments, one or both of the first and second regeneration airflows include atmospheric air. In some embodiments, any one of the first or second regeneration airflow is exhausted by a fuel cell system and the first gas entrained in the gas mixture is CO₂. In some embodiments, one or both of the regenerable adsorption material for the CSA-based STS and the regenerable adsorption material for the TSA-based STS include granules with a surface area from about 4 mesh to about 140 mesh.

Some embodiments of the current disclosure include a multi-stage system for reducing a concentration of a first gas entrained in a gas mixture, the system comprising: a plurality of staged treatment systems (STSs) including at least one concentration swing adsorption (CSA)-based STS and at least one temperature swing adsorption (TSA)-based STS. In some embodiments, the CSA-based STS comprises: at least one CSA-stage treatment assembly (CTA) and at least one CSA-stage treatment assembly (CTA) each including: a CTA inlet configured to receive at least a portion of a gas mixture having a first gas entrained therein; a CTA regenerable adsorbent material (CRAM) configured to treat the gas mixture during a CTA adsorption phase (CAP) by adsorbing at least a portion of the first gas from the gas mixture when the gas mixture is flowed over and/or through the CRAM, the CRAM configured to be cycled between the CAP and an CTA regeneration phase (CRP), the CRP configured to release at least a portion of first gas adsorbed by the CRAM during the CAP via a CSA cycle into a CSA regeneration airflow (CAF), the CAF configured to flow over and/or through the CRAM during the CRP; and a CSA-stage outlet (CO) for expelling the treated gas mixture from the CTA. In some embodiments, the TSA-based STS comprises: at least one TSA-stage treatment assembly (TTA) each including: a TTA inlet configured to receive the gas mixture from the CO; a TTA regenerable adsorbent material (TRAM) configured to treat the gas mixture during a TTA adsorption phase (TAP) by adsorbing at least a portion of the first gas remaining in the gas mixture after having been treated by the CTA when the gas mixture is flowed over and/or through the TRAM, the TRAM configured to be cycled between the TAP and a TTA regeneration phase (TRP), the TRP configured to release at least a portion of first gas adsorbed by the TRAM during the TAP via a TSA cycle into a TSA regeneration airflow (TAF), the TAF configured to flow over and/or through the TRAM during the TRP; and an TTA outlet (TO) for expelling the treated gas mixture from the TTA.

In some embodiments, the gas mixture is to enter a fuel cell system following treatment by any of the plurality of STS, the first gas entrained in the gas mixture is CO₂, and one or both of the first and second regeneration airflows include nitrogen exhausted from the fuel cell system. In some embodiments, the treatment assembly comprises a plurality of stacked regenerable adsorption materials forming a STS, wherein at least a first stack comprises a CSA-stage treatment system or a TSA-stage treatment system. In some embodiments, the treatment assembly comprises a column.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a schematic illustration of a multistage scrubber for removing molecules from gas mixtures, according to some embodiments.

FIGS. 2A-C show an example multistage scrubber for removing molecules or a gas from gas mixtures, containing sorbents in a V-bank configuration, according to some embodiments.

FIG. 3 shows an example multistage scrubber for removing molecules or a gas from from gas mixtures, containing sorbents arranged in a column configuration, according to some embodiments.

FIG. 4 shows an example multistage scrubber for removing molecules or a gas from from gas mixtures, containing sorbents of different sizes arranged in a column configuration in series, according to some embodiments.

FIG. 5 shows an example multistage scrubber for removing molecules or a gas from from gas mixtures, containing sorbents of different sizes arranged in a column configuration in parallel, according to some embodiments.

FIG. 6 shows a schematic illustration a source of heat for use in regenerating adsorbents of a multistage scrubber configured for removing molecules or a gas from from gas mixtures, according to some embodiments.

FIG. 7 shows an example illustration of the use of a multistage scrubber for removing CO₂ from gas mixtures of fuel cells, according to some embodiments.

FIG. 8 shows an example plot depicting the reduction in CO₂ concentration of a gas mixture via the use of the multistage scrubber disclosed herein, according to some embodiments.

### DETAILED DESCRIPTION OF SOME OF THE EMBODIMENTS

In some embodiments, there is a system comprising a single or multiple treatment assemblies that are configured for relatively swift and repeated separation of a relatively highly concentrated gas or gases from a gas mixture by a relatively small amount of sorbent (also referred to adsorbent interchangeably throughout the current disclosure). In some embodiments, the swift separation may be achieved by an adsorption cycle of about 10 minutes or less, about 5 minutes or less, about 2 minutes or less, about 1 minute or less, about half a minute or less, including values and subranges therebetween. The repeated separation of the system may be attributed to the regenerative capabilities of the system, which allow for the removal of the adsorbed gas from the sorbent during a regeneration cycle of aforementioned time durations. The small amount of sorbent may comprise less than about 20 kilograms of pre-adsorbed sorbent, less than about 10 kilograms of pre-adsorbed sorbent, less than about 5 kilograms of pre-adsorbed sorbent, less than about 2 kilograms of pre-adsorbed sorbent, less than about 1 kilograms of pre-adsorbed sorbent, less than about 0.5 kilograms of pre-adsorbed sorbent, any amount between about 5 grams and about 20 kilograms, including any values and subranges therebetween. The separation of a relatively highly concentrated gas from a gas mixture may include removal of more than about 1% (=10,000 ppm) of the gas (e.g., containing unwanted molecules desired for removal) from the gas mixture, about more than 2% (=20,000 ppm) of the gas from the gas mixture, about more than 10% (=100,000 ppm) of the gas from the gas mixture, or about more than 20% (=200,000 ppm) of the gas from the gas mixture. In some embodiments, the disclosed system may be configured to scrub gas mixtures containing from about 1% to about 80%, from about 5% to about 80%, from about 10% to about 80%, from about 20% to about 80%, from about 40% to about 60%, including values and subranges therebetween, of concentration of unwanted molecules or gas so as to remove at least a substantial amount (including all) of the unwanted gas. The system may be configured to operate continuously by providing treated gas mixtures during many hours in a day or even all day. In some embodiments, a continual or at least substantially continual operation may be facilitated by the use of a plurality of treatment assemblies which allow for one or more assemblies to be in an adsorption phase while other assemblies are in regeneration phase. The system may be durable for long term with a relatively long shelf life of a few weeks, months to years due to the regenerative capabilities of the sorbent.

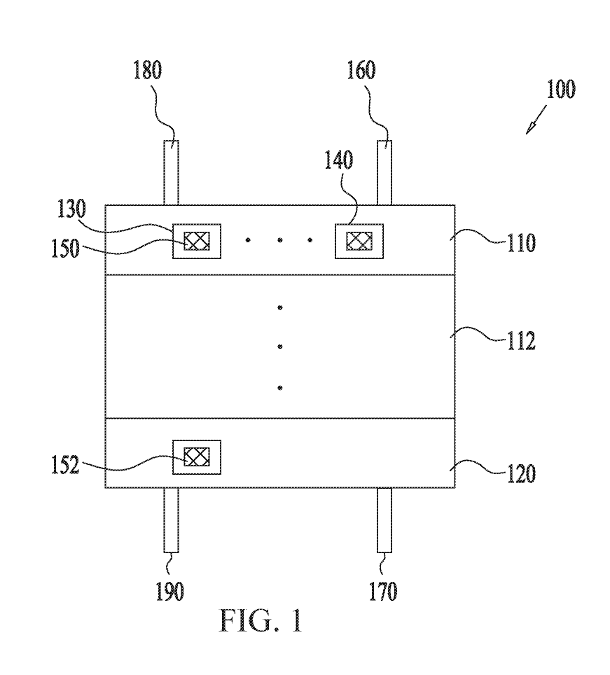

FIG. 1 shows a schematic illustration of a multistage scrubber for removing unwanted gas or molecules from gas mixtures, according to some embodiments. The multistage scrubber 100 may include a plurality of stages, each stage comprising one or more scrubbing modules 130, 140 that include adsorbents configured to adsorb and remove unwanted gas or molecules from a flowing mixture of gas traversing the multistage scrubber. The number of stages can range from two to as many stages as possible within the limitations of practical considerations such as portability, size constraints, etc. For example, the number of stages can be in the range from about 2 to about 30, from about 2 to about 25, from about 2 to about 20, from about 2 to about 10, from about 2 to about 8, from about 2 to about 6, from about 3 to about 6, from about 4 to about 6, about 4, about 3, including any value and subranges therebetween.

In some embodiments, each stage comprises at least one module containing an adsorbent configured to adsorb and remove molecules from a flowing mixture of gas during an adsorption phase of an adsorption-regeneration swing cycle of the module. In some embodiments, the swing cycle may be a concentration swing adsorption (CSA) cycle where, during the regeneration phase of the cycle, a purging fluid dilutes the concentration of molecules adsorbed by the adsorbent and flows out the molecules. In some embodiments, the swing cycle may be a temperature swing adsorption (TSA) cycle where, during the regeneration phase of the cycle, the temperature of the adsorbent and/or a purging fluid is raised to assist with the desorption of the molecules adsorbed to the adsorbent. In some embodiments, such TSA modules may comprise a heat source to effect the raising of the temperature of the adsorbent and/or the purging fluid. In such embodiments, the purging fluid flows out the molecules or gas desorbed from the adsorbent with the aid of heat (e.g., either due to a heated purging fluid or a heated adsorbent). In some embodiments, the swing cycle may be a pressure swing adsorption (PSA) cycle.

It is to be understood that the aforementioned swing adsorption techniques can be similar to each other in that there is an adsorption phase (where the molecules are adsorbed or captured by the adsorbents) and a desorption or regeneration phase where captured gas or adsorbate is removed from the sorbent by means of a flow of purge gas. In some embodiments, the distinctions between the different swing adsorption techniques may not be clear-cut. For example, in some embodiments, the boundaries between CSA and TSA may overlap. In such situations, the swing adsorption techniques can be distinguished based on an identification of the primary driver of the desorption process. For example, in CSA, the primary driver of desorption may the purging fluid or gas that has a lower concentration of the adsorbate entrained therein, which may allow the purging gas to capture the desorbed adsorbate and flow it away from the adsorbent. With reference to the TSA, in some embodiments, the primary driver of the desorption process can be an elevated temperature (either the purging gas and/or the adsorbent) during regeneration, which can assist in desorbing the adsorbate or molecules adsorbed onto the adsorbents. In some embodiments, these techniques work very well when the initial concentration level of the molecules to be removed (e.g., CO₂) is already quite low or when the purge gas contains little or no amount of the molecules to be removed.

Further, in general, the difference between the regeneration and adsorption temperatures in TSA can be larger than the difference with respect to the CSA.

In some embodiments, as discussed above, the number of stages of the multistage scrubber 100 may range from two to as many stages as possible (within constraints). In some embodiments, each stage may be configured to include any number of modules. For example, the first stage may include a plurality of modules (including any one of TSA-, CSA- and PSA-types, for example), ranging from about 1 to about 20 modules, from about 1 to about 10 modules, from about 1 to about 6, about 5 modules, about 4 modules, about 3 modules, about 2 modules, including any value and subranges therebetween. In the embodiments where a given stage includes a plurality of modules (e.g., two modules), in some embodiments, the operation of the multistage scrubber may be at least substantially continuous as one or more of the modules may be in adsorption phase while some or all of the rest of the modules are in regeneration phase. For example, the first stage may contain two CSA-modules (e.g., modules where the primary mechanism of the regeneration process follows from the fact that the purging fluid or gas contains a low concentration of the adsorbate molecules (e.g., compared to the concentration of adsorbates on the adsorbents) so that the purging fluid or gas can entrain and flow away the adsorbates adsorbed onto the adsorbents).

In some embodiments, the number of stages may be two, and in such embodiments, the first stage 110 contains at least one CSA module while the second (last) stage 120 may contain at least one TSA module. In some embodiments, the first stage 110 may not include a TSA module. In some embodiments, the first stage 110 may also include a TSA module and/or the second stage 120 may include a CSA module. In some embodiments, the number of modules in the second stage 110 may be no greater than the number of modules in the first stage 120. As an example, the first stage 110 may contain two CSA modules that are configured to operate in different phases of the adsorption-regeneration cycle (i.e., when one is in adsorption phase adsorbing molecules or gases from the gas mixture, the other module is in regeneration phase desorbing adsorbates into a purging gas).

In some embodiments, there may be one or more intermediate stages 112, and in such embodiments, the multistage scrubber 100 may be configured such that preceding stages (such as the first stage 110) include more modules than subsequent stages (such as 112 and 120). For example, the first stage 110 and the intermediate stages 112 may include several CSA and/or PSA modules, with the former having more modules (e.g., up to 20, 10, 5, 4 modules) than the latter. In such embodiments, the last stage 120 may include fewer total number of modules than either the first stage 110 or the intermediate stages 112, including fewer number of CSA and/or PSA modules (if at all). The last stage 120, however, may include more TSA modules than both the first stage 110 and the intermediate stages 112. For example, the last stage 120 may include one TSA module while both the first stage 110 and the intermediate stages 112 have none.

In some embodiments, the stages 110, 112 and 120 of the multistage scrubber 100 may be configured such that the concentration of molecules or gas one wishes to remove (e.g., CO₂) from a gas mixture entering the multistage scrubber 100 via the adsorption inlet 160 is reduced by several orders of magnitude when the treated gas mixture exits the multistage scrubber 100 via the adsorption outlet 170 within a relatively short period of time (e.g., within a few minutes). For example, a gas mixture containing CO₂ at a concentration of about 20% (200,000 ppm) and traversing through the multistage scrubber 100 (from adsorption inlet 160 to adsorption outlet 170) may be scrubbed by the multistage scrubber 100 such that the scrubbed gas mixture may have a CO₂ concentration of about 0.0002% (2 ppm), resulting in about five orders of magnitude reduction in the CO₂. In some embodiments, the gas mixture may contain up to about 80% of CO₂ (e.g., CO₂ makes up about 80% of the gas mixture), and the multistage scrubber 100 may be configured to remove at least a substantial amount (including all) of the CO₂ as the gas mixture traverses through the scrubber 100. In some embodiments, the concentration of the CO₂ may be from 1% to about 80%, from about 5% to about 80%, from about 10% to about 80%, from about 20% to about 80%, from about 40% to about 60%, including values and subranges therebetween, of the gas mixture, and the scrubber may remove from about 50% to about 99%, from about 50% to about 95%, from about 50% to about 90%, from about 60% to about 99%, from about 75% to about 99%, from about 75% to about 95%, from about 75% to about 90%, including values and subranges therebetween, of CO₂ from the gas mixture. It is to be understood that this example is not limited to CO₂ and equally applies to other types of molecules with the use of proper adsorbents capable of adsorbing the other molecule types. For example, with the use of proper adsorbents capable of adsorbing gases such as ammonia, hydrogen, water, carbon monoxide, urea, etc., the disclosed multistage scrubber 100 may scrub a gas mixture containing any of these gases to reduce their concentration in the gas mixture by up to about five orders of magnitude.

In some embodiments, the embodiments of the current disclosure may be used to remove or scrub from a gas mixture more than one type of molecules or gases. For example, modules or treatment assemblies with different types of adsorbent may be used to adsorb the more than one type of molecules or gases from a gas mixture. In some embodiments, each module may contain multiple types of adsorbents, allowing each module to scrub different types of molecules or gases from the gas mixture. For example, with the use of different types of adsorbents, the embodiments of the current disclosure may be used to scrub or remove CO and CO₂ from a gas mixture.

In some embodiments, the aforementioned large reduction in the concentration of the molecules or gas to be removed from a gas mixture may be performed in stages. For example, using CO₂ as a non-limiting example, for a multistage scrubber 100 comprising a first stage 110 including at least one CSA module (in some instances, with no TSA module) and a last stage 120 including at least one TSA module, the first stage 110 may be configured to reduce the concentration of CO₂ in the gas mixture by at least five orders of magnitude (e.g., a concentration of about 80% (800,000 ppm) may be reduced to about 0.0001% (1 ppm)). In some embodiments, the reduction may be from about 50% (500,000 ppm) to about 0.1% (1000 ppm), from about 50% (500,000 ppm) to about 1% (10,000 ppm), from about 50% (500,000 ppm) to about 2% (20,000 ppm), from about 50% (500,000 ppm) to about 5% (50,000 ppm), from about 50% (500,000 ppm) to about 10% (100,000 ppm), including any values and subranges therebetween. In some embodiments, the above reductions may be performed by a plurality of stages that include the first stage 110, each stage containing no TSA module (e.g., all the stages but the last stage 120 containing no TSA module).

As an example, the first stage 110 may include at least two CSA modules or treatment assemblies, and after treatment by the first stage, the concentration of CO₂ may be reduced from about 80% by an amount in the range from about 50% to about 99%, from about 50% to about 95%, from about 50% to about 90%, from about 75% to about 99%, including values and subranges therebetween. This reduction may occur in a short period of time, for example, the duration may be in the range from about 5 seconds to about 300 seconds, from about 5 seconds to about 240 seconds, from about 5 seconds to about 180 seconds, from about 5 seconds to about 120 seconds, from about 5 seconds to about 60 seconds, from about 51 seconds to about 60 seconds, from about 10 seconds to about 30 seconds, including values and subranges therebetween. In such embodiments, at least one of the at least two CSA modules may be adsorbing CO₂ while at least another one of the at least two CSA modules are regenerating. Such arrangement may allow the first stage 110 to operate at least almost continuously in scrubbing the gas mixture containing CO₂. As noted above, it's to be understood that CO₂ is an illustrative example, and the above embodiments equally apply to other molecules and gases.

Referring to the example in the preceding paragraph, in some embodiments, the last stage 120 of the multistage scrubber 100 may receive the gas mixture after the gas mixture is scrubbed or treated by the first stage 110 (or the plurality of stages preceding the last stage 120). In such embodiments, the CO₂ concentration of the scrubbed gas mixture may be in the range from about 10% (100,000 ppm) to about 0.1% (1000 ppm), having been reduced from about 50% (500,000 ppm) or less or from about 30% (300,000 ppm) or less or from about 20% (200,000 ppm) or less. In such embodiments, the last stage 120 containing at least one TSA module may further reduce the CO₂ concentration (via adsorption onto the adsorbents of the TSA module(s) as well as CSA modules, if present) to a range of from about 1% (10,000 ppm) to about 0.0001% (1 ppm), from about 0.1% (1000 ppm) to about 0.0001% (1 ppm), from about 0.01% (100 ppm) to about 0.0001% (1 ppm), from about 0.1% (1000 ppm) to about 0.01% (100 ppm), from about 0.01% (100 ppm) to about 0.0001% (1 ppm), including all values and subranges therebetween. In some embodiments, the above reductions may be performed by a plurality of stages that include the last stage 120, each stage containing at least one TSA module. As noted above, the above discussion is not limited to CO₂ and applies equally to other gases that one wishes to remove from a gas mixture, provided one selects absorbents capable of adsorbing the unwanted molecules or gas.

In some embodiments, besides the number of stages of the multistage scrubber 100, other parameters of the scrubber 100 may also be varied so as to reduce the concentration of various molecules or gases one wishes to remove from a gas mixture by several orders of magnitude. For example, the number and type of modules (e.g., type including CSA-type, TSA-type, PSA-type, etc.), the size, configuration, geometry, type, etc., of the adsorbents in each module, the kinetics and capacity of the modules/adsorbents (e.g., adsorption and regeneration capacity, swing cycle duration, rate of cool down after heating up with reference to TSA type modules, etc.) and/or the like may be varied so as to arrive at the aforementioned reductions in concentration of a molecule or gas to be scrubbed from the gas mixture. For instance, the first stage 110 may contain more number of modules than subsequent stages 112, 120, and the modules in the first stage 110 may be CSA modules only while the latter stages such as the last stage 120 may contain TSA modules as well.

In some embodiments, the first stage 110 that receives the gas mixture from the adsorption inlet 160 may contain any number of TSA, PSA and/or CSA modules. In some embodiments, however, the first stage 110 or the first few stages (if the multistage scrubber 100 contains several stages, for example) may comprise only CSA modules; i.e., all the modules in the first stage 110 (or the first few stages) may contain adsorbents that are configured to undergo only CSA swing cycle for adsorption/regeneration. In some embodiments, this may be advantageous because owing to the fact that the gas mixtures received by the first stage(s) usually contain the largest concentration of molecules to be adsorbed (by virtue of being the first to receive the gas mixture, for example), the adsorbents of the modules in the first stage(s) may saturate rapidly during adsorption phases (all things being at least substantially equal, for example). In such embodiments, one may elect to have CSA modules in the first stage(s) (to a large extent or exclusively) since CSA modules have shorter adsorption-regeneration cycles compared to, for example, TSA modules (since there can be a lag time at least due to the time it takes for adsorbents to cool down). In some embodiments, the adsorbents of the modules of the first stage(s), whether CSA-only or including other types of modules, may be selected so that the period or duration of the adsorption-regeneration cycles of the adsorbents is lower than those in the subsequent stages (e.g., 112 or 120).

In some embodiments, later stages such as the last stage 120 may include at least one TSA modules. As discussed above, TSA modules experience higher temperatures during regeneration which assists in the desorption of adsorbed gases from the adsorbents. In some embodiments, the change in the temperatures of the adsorbents between an adsorption phase and regeneration phase of a TSA module may be in the range from about 10° C. to about 150° C., from about 10° C. to about 120° C., from about 10° C. to about 100° C., from about 20° C. to about 100° C., from about 30° C. to about 80° C., from about 40° C. to about 60° C., including values and subranges therebetween. For example, the regeneration temperature of the sorbents in the TSA modules may range from about 10° C. to about 150° C., from about 20° C. to about 120° C., from about 30° C. to about 150° C., from about 30° C. to about 120° C., from about 50° C. to about 100° C., including values and subranges therebetween, while the adsorption temperatures can range from about 10° C. to about 100° C., from about 10° C. to about 70° C., from about 10° C. to about 40° C., from about 10° C. to about 30° C., including values and subranges therebetween.

CSA modules, in contrast, can experience much less or no temperature difference between the adsorption and regeneration phases. For example, the adsorption temperature of the sorbents in the CSA modules may range from about 10° C. to about 100° C., from about 20° C. to about 80° C., from about 30° C. to about 75° C., from about 40° C. to about 75° C., from about 50° C. to about 60° C., including values and subranges therebetween, while the regeneration temperature may deviate from the adsorption temperatures by at most about 10° C., about 8° C., about 5° C., about 3° C., about 0° C., including values and subranges therebetween.

In some embodiments, the number of modules of the first stage 110 or the first few stages containing no TSA modules (which may be the case if there are several stages in the multistage scrubber 100) may also be selected so as to facilitate the adsorption of a larger amount of molecules by the first stage 110 (or first few no-TSA module stage(s)) from a gas mixture when compared to the amount that would be adsorbed in latter stages. That is, in some embodiments, the number of modules in the first stage 110 may be configured such that, all other things being at least substantially equal, more molecules are adsorbed by the adsorbents in the first stage 110 than those in any one of the subsequent stages. For example, the number of modules in the first stage 110 (130 and 140 in FIG. 1, for example) may be larger or at least no less than the number of modules (152 in FIG. 1, for example) in any of the subsequent stages 120. In some embodiments, the total number of modules in the first stage 110 (or each of the first stages that contain no TSA modules, for example) of the multistage scrubber 100 may be in the range from about 2 to about 10, from about 4 to about 10, from about 6 to about 10, from about 4 to about 8, including values and subranges therebetween, while the total number in the latter stages (containing TSA modules, for example) may be lower.

In some embodiments, the size, configuration, geometry, type, etc., of the adsorbents in the modules of the first stage 110 or the first few stages (in particular if there are several stages in the multistage scrubber 100) may be selected so as to facilitate the adsorption of a larger amount of molecules by the first stage 110 (or first few stage(s)) from a gas mixture when compared to the amount that would be adsorbed in latter stages. For example, the adsorbents 150 in the first stage 110 may be larger in size so as to adsorb higher amounts of molecules from the gas mixture (when compared to adsorbents 152 of modules of subsequent stages, for example). In some embodiments, the adsorbents in each module of the first stage(s) (110 or 112) may be larger in size than adsorbents in the subsequent stages (112 or 120, respectively). In some embodiments, the total size of the adsorbents in the first stage (or any one of the first stages) may be larger than the total size of the adsorbents in any stage of the subsequent stages. In any case, the adsorbents in the first and latter stages may be sized such that, all other things being at least substantially equal, more molecules are adsorbed by the adsorbents in the first stage 110 than those in any one of the subsequent stages. In some embodiments, similar consideration as above applies with respect to configuration, geometry, type, etc. of the adsorbents. That is, in some embodiments, one or more of these parameters of the adsorbents in each of the modules may be selected such that a preceding stage of the multistage scrubber 100 reduces the concentration of molecules or gases in a gas mixture to be scrubbed by the adsorbents by no less amount than any succeeding stage.

In some embodiments, the scrubbing efficiency of the multistage scrubber 100 may depend on the type of adsorbents used in the modules included in the scrubber 100. For example, in several of the examples discussed herein, CO₂ has been presented as an example of a gas that one may wish to remove or scrub from a gas mixture using the multistage scrubber 100 disclosed herein. In some embodiments, amines can be used to adsorb CO₂; however, there are several types of amines with varied adsorption efficiencies, and the scrubbing efficiency of the scrubber 100 may depend on the choice of amine included in the sorbents. In some embodiments, the sorbents can be solid-supported amines, such as but not limited to amine-polymers, including linear and/or branched triethylenetetramine (TETA), tetraethylenepentamine (TEPA), pentaethylenehexaamine (PEHA); triethylamine (TEA), monoethanolamine (MEA), ethanolamine, methylamine, polyethyleneimine (PEI), diethanolamine (DEA), dimethylamine, diethylamine, diisopropanolamine (DIPA), methyldiethanolamine (MDEA), methylethanolamine, polyethilenamine, and combinations thereof. Further, examples of the solid support that can be used for the adsorbents include gels, molecular sieves, nanotube-containing materials, porous materials, sponge and sponge-like materials, electro-magnetically charged objects, porous organic polymers, ion exchange resins, polymeric absorbent resins, acrylic ester polymers, polystyrene divinyl benzene, polymethyl methacrylate (PMMA), polystyrene, styrene divinylbenzene (SDB), fly ash, activated carbon, carbon nanotubes, alumina nanoparticles, zeolite, synthetic zeolite, alumina, porous alumina, porous minerals, silica, porous silica, silica nanoparticle, fumed silica, activated charcoal, aluminum phyllosilicates, bentonite, montmorillonite, ball clay, fuller's earth, kaolinite, attapulgite, hectorite, palygorskite, saponite, sepiolitemetal, organic frameworks, molecular sieves, alumina, natural or synthetic porous carbon or metal organic frameworks, and one or more combinations thereof.

Similarly, for other gases such as ammonia, hydrogen, urea and/or the like that one wishes to remove from a gas mixture, different types of adsorbents can be used resulting in different scrubbing efficiency for the multistage scrubber 100. Further examples include acidic gases, carbon monoxide, sulfur oxide, nitrous oxide, radon, etc., and/or the like. In some embodiments, the gas mixture may comprise contaminates to be removed by the adsorbent such as inorganic compounds, organic vapors, micro-organisms such as but not limited to bacteria, viruses, mold, fungi, airborne particles.

In some embodiments, the multistage scrubber 100 may include one or more regeneration inlets 180 for allowing purging air into the scrubber 100 during the regeneration phases of any of the modules in the scrubber. Further, the multistage scrubber 100 may also include one or more regeneration outlets 190 for releasing the purging air containing some or all of the molecules or gases desorbed from the regenerated adsorbents of the modules of the scrubber 100.

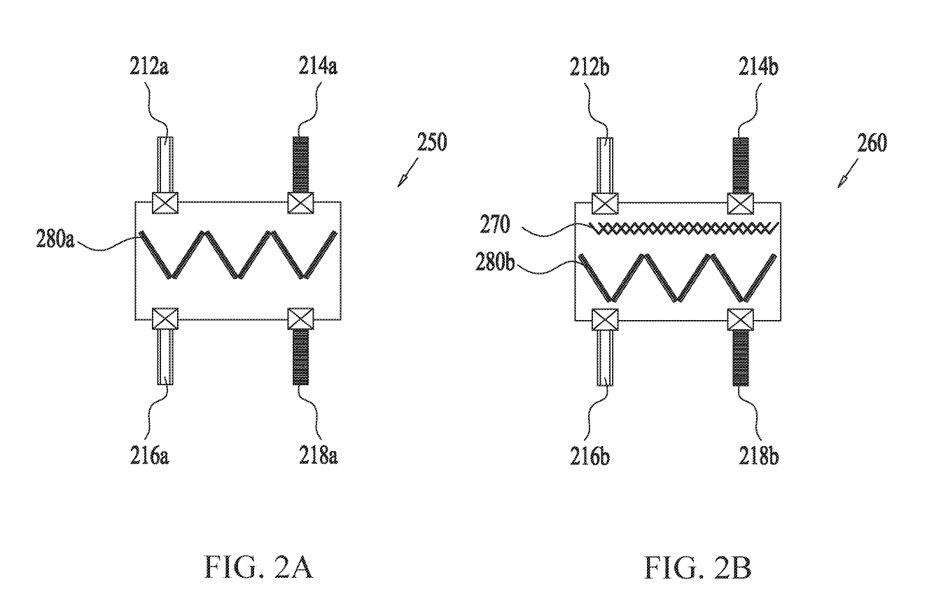

FIGS. 2A-C show an example multistage scrubber for removing unwanted molecules or gas from gas mixtures containing sorbents in a V-bank configuration, according to some embodiments. In some embodiments, the multistage scrubber 200 includes four stages of adsorption-regeneration swing cycles arranged in series, the first three stages 210, 220, 230 comprising CSA-modules only (i.e., including no TSA module) while the last stage 240 including TSA modules only (i.e., including no CSA module). As noted above, other embodiments can include more or less number of stages as well as different numbers of CSA and TSA modules for each stage. As depicted in the example embodiment of FIG. 2C, the modules can be arranged in parallel configuration. In some embodiments, both the stages and the modules can be arranged in either series or parallel configuration, or combination thereof. One difference between the CSA module 250 and the TSA module 260 shown in FIG. 2A and FIG. 2B, respectively, is the presence of a heating coil 270 in the latter for use in heating a purging fluid and/or the adsorbent 280b during the regeneration phase of the TSA module 260. In some embodiments, each of the CSA module 250 and the TSA module 260 includes two inlets 212, 214, configured to receive gas mixtures and purging fluid for scrubbing and regeneration, respectively, as well as two outlets 216, 218 configured to release scrubbed gas mixture and outgoing purging fluid. In some embodiments, the adsorbent beds 280a, 280b may comprise a plurality of flat sections forming a V-bank, designed to reduce pressure drop. The flow of the gas mixture and/or the purging fluid through the modules 250, 260 may be facilitated by a fan and/or a pump (not shown) or by high static pressure at the gas source.

In the example embodiment of FIG. 2C, the first stage 210 of the multistage scrubber 200 has four parallel CSA modules that use ambient air regeneration to reduce CO₂ levels in an incoming fluid from L₀ to L₁, L₀ representing the level of CO₂ concentration in the incoming fluid and L₁ representing CO₂ concentration in the scrubbed fluid exiting the first stage. As discussed in detail above, in some embodiments, the scrubbing efficiency of the first stage may depend on one or more of the type of adsorbents used in the CSA modules, the sorbent bed dimensions and configuration, the flow rate of the incoming fluid, and the timing of the regeneration cycles, pressure (e.g., the pressure difference (ΔP), measured between the inlet and outlet of the scrubber) of the adsorbents, among other things. In some embodiments, the second stage 220 receives the output of the first stage 210, and uses three parallel CSA modules to reduce the CO₂ levels further from L₁ to L₂. The transfer of the scrubbed gas mixture from the first stage 210 to the second stage 220 (and generally between any two stages), may be accomplished by a network of conduits 262 configured to connect each module of a stage to an input from the previous stage and an output to the next stage, as well as to a regeneration purging fluid flow and an exhaust for the purging flow.

In some embodiments, the modules of the second stage may be different at least in some features from the modules of Stage 1, such features including one or more of adsorbent type, adsorbent bed configuration, fluid flow rate (of gas mixture and/or purging fluid) and adsorption-regeneration cycle durations. In some embodiments, similarly, the third stage 230 receives the output of the second stage 220, and uses several CSA modules to reduce the CO₂ concentration level from L₂ to L₃. Here again, in some embodiments, the third stage 230 may include CSA modules having features different from the modules of one or both of the first stage 210 and the second stage 220, including sorbent type, sorbent bed configuration, fluid flow rate and cycle durations. Finally, the last stage 240 uses two TSA modules, each module configured with heaters 250a and 250b for assisting with regeneration of the adsorbents, to effect the final reduction of CO₂ levels from L₃ to Lₒᵤₜ. In some embodiments, the entire process from receiving the incoming fluid with L₀ level of CO₂ to releasing the treated fluid with Lₒᵤₜ level of CO₂ may be accomplished relatively quickly (e.g., less than about 15 minutes, about 10 minutes, about 5 minutes, about 3 minutes, about 1 minute, about 30 seconds, including values and ranges therebetween).

In some embodiments, the adsorption-regeneration cycles of the first stage(s), which may contain CSA-modules only, may be very short (e.g., less than about 5 minutes, about 3 minutes, about 2 minutes, about a minute, about 5 to 30 seconds, including values and subranges therebetween).

As an example illustration, in some embodiments, the concentration L₀ of CO₂ in the incoming fluid can be about 80% (800,000 ppm) or less, 50% (500,000 ppm) or less 20% (200,000 ppm) or less, in the range from about 10% (100,000 ppm) to about 20% (200,000 ppm), less than about 10% (100,000 ppm), less than about 1% (10,000 ppm), less than about 0.1% (1000 ppm), less than about 0.05% (500 ppm), including values and subranges therebetween, while the concentration Lₒᵤₜ of CO₂ in the fluid after scrubbing by the multistage scrubber 200 can be in the range from about 0.001% (10 ppm) to about 0.01% (100 ppm), from about 0.0001% (1 ppm) to about 0.01% (100 ppm), from about 0.0005% (5 ppm) to about 0.01% (100 ppm), including values and subranges therebetween. A reduction from L₀ of about 20% (200,000 ppm) to Lₒᵤₜ of about 0.0001% (1 ppm) represents a significant level of CO₂ scrubbing or removal in a short time as stated above.

In some embodiments, the first stage 210 receives the highest levels of CO₂ (since it is receiving the incoming air prior to scrubbing by any stages of the multistage scrubber 200) and, all else being equal, the sorbent may saturate rapidly. In some embodiments, larger overall sorbent volumes and short regeneration cycles may counter the rapid saturation of the sorbent by CO₂. Furthermore, maximal throughput is more likely to be accomplished by operating the concentration swing primarily off the center of the dynamic range and substantially avoiding the tail of the adsorption process (where adsorption rates diminish) and/or the tail of the regeneration process where desorption rates diminish.

In some embodiments, the subsequent CSA stages 220, 230 may have smaller sorbent volumes, with appropriate adjustments to geometry and cycle durations, and may also use sorbents with different tradeoff between kinetics and capacity. In most cases, the earlier stages of the multistage scrubber 200 may have less selectivity, since the CO₂ level in the received gas mixture is relatively high. The earlier stages, however, may have high capacity and very fast kinetics, so as to maximize or at least increase the mass of CO₂ adsorbed from the gas mixture and removed for a given total gas flow rate. As one proceeds to later stages, higher differential selectivity for CO₂ may become more important whereas the volumetric efficiency becomes less so.

In some embodiments, the final TSA stage 240 is different: the sorbents may be different than those used for the CSA modules. Further, the temperature swing potentially allows very low CO₂ levels in the output stream, despite the use of ambient air containing up to about 400 ppm CO₂ for the regeneration of the adsorbents. However, regeneration times may be long due to the time it takes to first heat the sorbent bed and then cool it down. Because of the long “down time” of each module associated with the regeneration, a larger number of parallel modules may be used in the TSA stage 240.

In some embodiments, one may wish to have at least one active scrubbing module at all times. As such, if the net operating time of each module is OT(i) and the total regeneration downtime is RT(i), the number of modules N(i) in stage i to have at least one active scrubbing module is given by the expression:

N(i)≥1+RT(i)/OT(i).

In some embodiments, the heating and cooling of the TSA modules during regeneration may be accomplished via closed loop heating so as to reduce the amount of time and energy required for heating. Examples of closed loop heating are described in PCT Patent Application No. PCT/US14/56097, filed Sep. 17, 2014, entitled “Systems and Methods for Efficient Heating of Sorbents in an Indoor Air Scrubber,” the disclosure of which is incorporated herein by reference in its entirety.

In some embodiments, the source of regeneration heat can be any suitable source. In some embodiments, waste heat or heat produced from the fuel cell or the feed gas cracker can be used, either directly or indirectly through an appropriate heat exchange configuration, for example. In some embodiments, to avoid or reduce the possibility of the sorbent being loaded with CO₂ from ambient air during cool down, the cool down may be accomplished with reduced air flow, or with no air flow at all, through the sorbent bed, and heat may be removed from the sorbents and the modules by conduction rather than convection. If the cooling process is slow, in some embodiments, this can be compensated for by using more adsorbent beds.

In some embodiments, instead of or in addition to atmospheric air (indoor or outdoor air, for example), any suitable and available gas stream with relatively low CO₂ content can be used as a source of purge fluid for regenerating the adsorbents. For example, nitrogen or other gas streams produced during the fuel cell cycle can be utilized for regeneration.

Examples of adsorbent beds are described in PCT Patent Application No. PCT/US215/015690, filed Feb. 12, 2015, entitled “Regenerable Sorbent Cartridge Assemblies in Air Scrubbers,” the disclosure of which is incorporated herein by reference in its entirety.

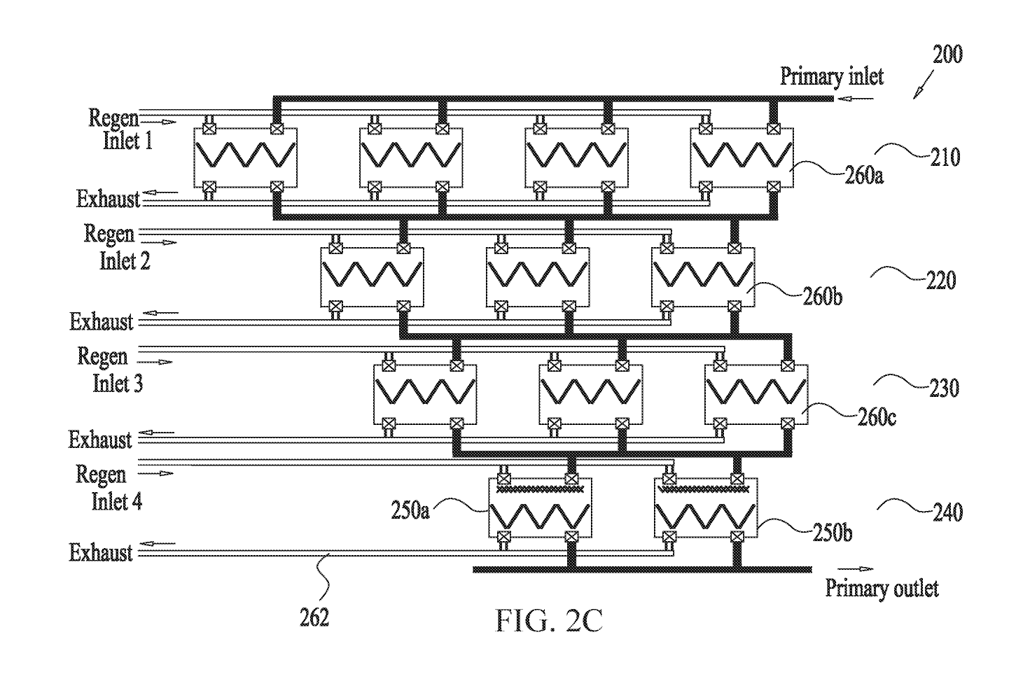

In some embodiments, the V-bank configuration of a shallow sorbent bed may be used to reduce pressure drop and maximize or increase flow throughput. In certain embodiments, the sorbent beds may be much deeper in order to achieve extensive removal of CO₂. In such embodiments, substantial gas throughput may be accomplished via higher pressure. If such pressure is readily available from the gas source, the system can take advantage of that available pressure by using thicker sorbent beds. Such beds may have a column configuration, such as the example embodiments shown in FIGS. 3-7, in lieu of the V-bank configuration shown in FIGS. 2A-C, which is designed to minimize or at least reduce pressure drop.

FIGS. 3-7 show several example embodiments of a multistage scrubber for removing unwanted molecules or gas from gas mixtures, the scrubber containing sorbents arranged in a column configuration. FIG. 3 shows three stages of adsorption-regeneration swing cycles linked in series, each stage containing four parallel column modules which may be a CSA module, a TSA module, a PSA, or combinations thereof (e.g. a TCSA module combining temperature and concentration swing cycle). It is to be noted that FIG. 3 is an example embodiment and that the multistage scrubber 300 can have any number of stages, and each stage can have any number of modules. In some embodiments, the first stage 310 may be configured for reducing an wanted gas (e.g., CO₂) concentration level of an incoming fluid from L₀ to L₁. In some embodiments, the efficiency with which the first stage 310 may accomplish such reduction may depend on one or more of the choice of sorbent, the sorbent material, dimension and configuration, the flow rate of the incoming fluid and/or the purging fluid, and the timing of its adsorption and regeneration cycles pressure, such as the pressure difference (ΔP), measured between the column inlet and outlet, among other things. Similar to the discussion above with reference to FIGS. 2A-C, in some embodiments, the second stage 320 receives the output of the first stage, and using four parallel modules, reduces the concentration of the unwanted gas from L₁ to L₂, which is further reduced to Lₒᵤₜ by the modules of the third stage 330. As noted above, some or all of the modules of the different stages may be different from each other and the differences may be based on type, dimension, configuration, etc., of the sorbent material, the flow rate of the incoming fluid and/or the purging fluid and cycle durations of the adsorption-regeneration cycles.

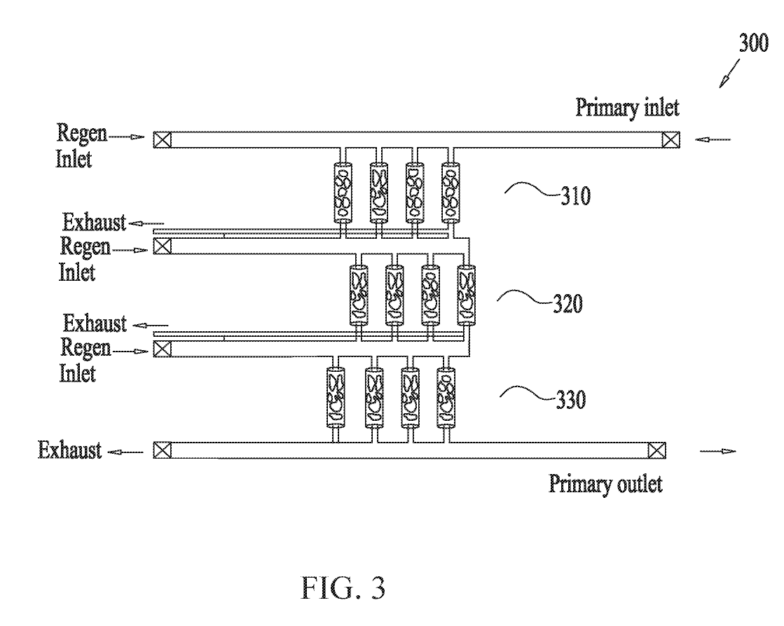

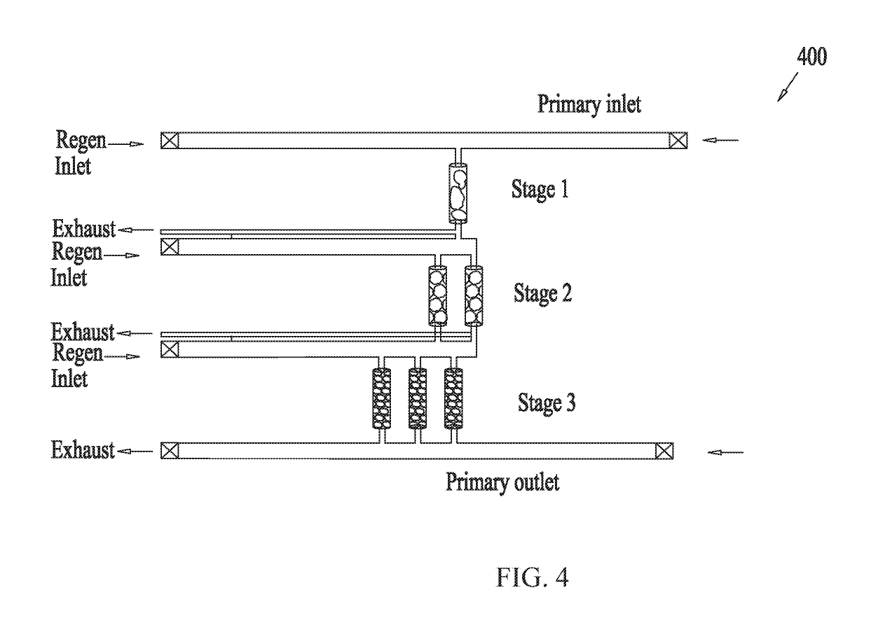

Similar to FIG. 3, FIG. 4 shows an example multistage scrubber 400 for removing unwanted molecules or gas from gas mixtures, the scrubber containing sorbents arranged in a column configuration. FIG. 4, however, shows three stages of adsorption-regeneration swing cycles linked in series, where the sorbent columns of any one stage contains different types of sorbents from the sorbent columns of a different stage. FIG. 5, on the other hand, shows example embodiments of a multistage scrubber 500 containing column modules having stacked sorbent layers. Similar to the embodiments of FIG. 3 discussed above, in some embodiments of FIGS. 4-5, the unwanted gas concentration level of an incoming gas mixture is reduced from an initial concentration level L₀ to a first intermediate concentration value L₁, from L₁ to a second intermediate concentration value L₂ and finally from L₂ to a final concentration value Lₒᵤₜ as the incoming gas mixture progresses through the columns from the first stage to the second and finally the third stage.

In some embodiments, the reduction in the concentration of the unwanted gas (e.g., CO₂) from L₀ to Lₒᵤₜ as described in reference to FIGS. 2A-C. In some embodiments, reductions may be obtained for flow rate of the incoming fluid (that contains the unwanted gas such as CO₂) ranging from about 5 liters per minute (lpm) to about 600 lpm, from about 5 lpm to about 500 lpm, from about 10 lpm to about 500 lpm, from about 15 lpm to about 500 lpm, from about 25 lpm to about 500 lpm, from about 40 lpm to about 500 lpm, from about 50 lpm to about 500 lpm, including values and subranges therebetween. The embodiments of FIGS. 3-7 may comprise valves, fans, blowers, pumps, shutters and dampers for directing the incoming air (to be adsorbed or for regeneration) in the appropriate manifold and scrubbing module. The operation of these components may be controlled by the controller.

In some embodiments, the concentration levels for embodiments of FIGS. 3 and 4 may be different from each other based on, amongst other things, the types of adsorbents in the columns of the scrubbers 400 and 500). For example, the surface area of the granules of the adsorbents contained within the columns shown in the embodiments of FIGS. 3-7 can vary from about 4 mesh to about 140 mesh, from about 4 mesh to about 100 mesh, from about 5 mesh to about 80 mesh, from about 5 mesh to about 60 mesh, from about 5 mesh to about 40 mesh, from about 4 mesh to about 20 mesh, less than about 20 mesh, less than about 40 mesh, including values and subranges therebetween. In some embodiments, the weight of the granules in each sorbent bed or column can be in the range from about 5 grams to about 500 grams, from about 10 grams to about 300 grams, from about 10 grams to about 200 grams, from about 50 grams to about 200, from about 75 grams to about 125 grams, including values and subranges therebetween. In some embodiments, the granules are contained within a column with a length in the range from about 5 cm to about 50 cm, from about 5 cm to about 30 cm, from about 5 cm to about 20 cm, from about 10 cm to about 20 cm, including values and subranges therebetween. In some embodiments, the diameter of the columns can be in the range from about 0.5 cm to about 5 cm, from about 1 cm to about 3 cm, from about 1.5 cm to about 2.5 cm, including values and subranges therebetween.

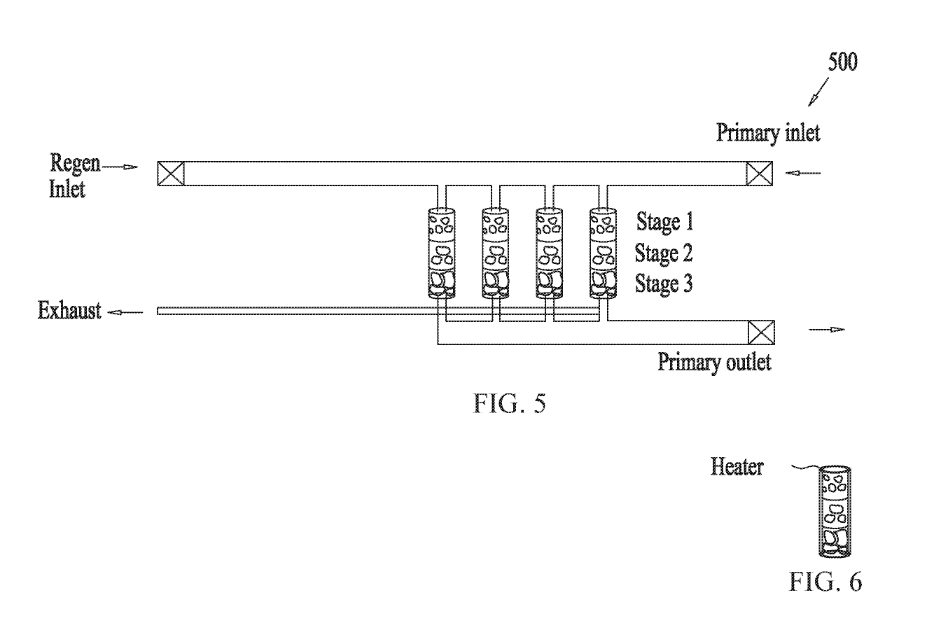

In some embodiments, FIG. 6 shows a schematic illustration a source of heat for use in regenerating adsorbents of a multistage scrubber configured for removing molecules from gas mixtures. In some embodiments, the heat source may be heated water or other liquid, such as oil, equipped with a water circulation pump for heating the adsorbents. In some embodiments, the heat source may comprise a coil or any other suitable means configured to heat the columns containing the adsorbents and establish suitable temperatures for adsorption and/or regeneration. In some embodiments, such temperature may be in the range from about 10° C. to about 150° C., from about 20° C. to about 120° C., from about 30° C. to about 100° C., from about 40° C. to about 80° C., from about 50° C. to about 60° C., including values and subranges therebetween. The duration for the adsorption-regeneration cycle period may range from about 0.5 minute to about 10 minutes, from about 1 minute to about 5 minutes, about 1 minute, about 2 minutes, about 3 minutes, about 4 minutes, including values and subranges therebetween.

In some embodiments, a single stage may comprise only a single treatment module. In some embodiments a single column module may comprise multiple layers of different type sorbents, wherein each layer constitutes a separate stage. The sorbent types may differ in any one or more properties such as amine type, solid support type, sorbent size and/or amount of sorbent, for example. In some embodiments, as seen in FIG. 6, the multistage system may comprise a single multistage column configured for performing multiple stages therein and in some embodiments, as seen in FIG. 5, the multistage system may comprise a plurality of multistage columns.

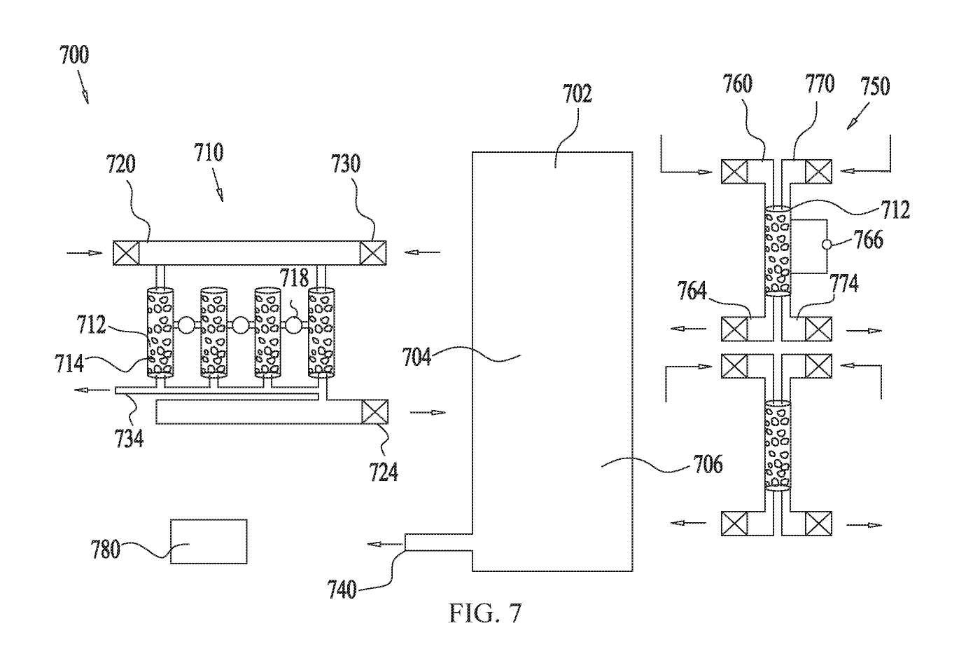

FIG. 7 shows an example illustration of the use of a multistage scrubber for removing CO₂ from gas mixtures of fuel cells, according to some embodiments. The fuel cell system 700 comprises a fuel cell 702 including a fuel side 704 and an air side 706. The fuel cell 702 may comprise any type of fuel cell, such as an alkaline fuel cell, for example. Any one of the multi-stage scrubbing systems described in reference to any of the preceding figures may be used to reduce the concentration level of CO₂ from L₀ to Lₒᵤₜ from the feed gas stream of the fuel side 704 and/or from the air stream (also referred to as the “feed gas stream”) of the air side 706.

In some embodiments, the CO₂ concentration level L₀ in the incoming feed gas stream at the fuel side 704 may be reduced using a multi-stage scrubbing system 710. The exemplary multi-stage scrubbing system 710, comprises four column modules 712 connected in series (or in parallel) via valves, dampers, compressors and/or controllers 718. Each column module may contain the same sorbent 714, as in FIG. 3, or a different sorbent in each column as in FIG. 4, or a combination of stacked sorbents, as in FIG. 5. The feed gas stream enters the multi-stage scrubbing system 710 via an adsorption inlet 720.

In a non-limiting example, the L₀ of the feed gas stream may be about 20% and may be reduced consecutively by the first column module to L₁, which may be about 5%, and thereafter reduced to L, being about 2000 ppm, by the second column module, and thereafter further reduced to L₃, being about 400 ppm, by the third column module and finally reduced to Lₒᵤₜ being about 5 ppm by the fourth column module. The now low concentration level feed gas stream enters the fuel side 704 via an adsorption outlet 724 and may be connected to the fuel cell 702 in any suitable manner such as via valves, dampers, compressors and/or controllers 718.

Regeneration of the column modules 712 may be performed in any suitable manner as described in reference to FIGS. 1-6 by a purge gas introduced into the regeneration inlet 730 which exits the multi-stage scrubbing system 710 via exhaust 734.

In a non-limiting example, the purge gas may comprise outdoor air or indoor air and/or air heated by closed loop heating as described above. In some embodiments, the purge gas may comprise gases produced by the fuel cell 702, such as nitrogen or other gas streams and may be exhausted from the fuel cell 702 via exhaust 740 at a relatively high temperature, such as above room temperature.

In some embodiments, the CO₂ concentration level L₀ in the incoming feed gas stream at the air side 706 may be reduced using a scrubbing system 750 or even a single scrubber module, here comprising the column module 712. The exemplary scrubbing system 750, comprises two column modules 712 connected in parallel via valves, dampers, compressors and/or controllers 718. Each column module may contain the same sorbent 714 as in FIG. 3, or a different sorbent in each column as in FIG. 4 or a combination of stacked sorbents, as in FIG. 5. The air gas stream enters the multi-stage scrubbing system 750 via an adsorption inlet 760.

In a non-limiting example, the L₀ of the air stream may be about 400 ppm and may be reduced by the first column module to Lₒᵤₜ, being about 5 ppm. The now low concentration level air stream enters the air side 706 via adsorption outlet 764 and may be connected to the fuel cell 710 in any suitable manner such as via valves, dampers, compressors and/or controllers 718.

Regeneration of the column modules 712 may be performed in any suitable manner as described in reference to FIGS. 1-6 by a purge gas introduced into the regeneration inlet 770 which exits the scrubbing system 750 via exhaust 774. In some embodiments, as the first column module 712 operates in the scrubbing (i.e. adsorption) mode the second column module 712 may be in the regeneration mode. In some embodiments, the heating may be performed by heated water equipped with a water circulation pump 766.

The operation of the system as a whole, as shown in FIGS. 1-6, may be orchestrated by controllers 780 (FIG. 7), such as electronic controllers, that determine which modules are performing scrubbing and which are undergoing regeneration at any point in time. The control is implemented by opening and closing the appropriate valves or dampers on the inlets and outlets of all the modules, using actuators or motors controlled by the main controller.

In some embodiments, the modules and systems described herein are not limited to CO₂ reduction and may be used for removal or reduction of any first gas or contaminants, from any second gas stream. Examples of such contaminants or gases include inorganic compounds, organic vapors, micro-organisms, such as but not limited to bacteria, viruses, mold, fungi, airborne particles, etc., acidic gases, gases, such as but not limited to carbon dioxide, carbon monoxide, sulfur oxide, nitrous oxide, radon, etc., and/or the like. The second gas stream (or feed gas stream) may comprise a fuel cell side feed gas or air or any other gas stream. In some embodiments, the column module 712 may be used for treating gas streams e.g. air streams for scrubbing gas stream contaminants in any suitable system, such as a Heating, ventilation and air conditioning (HVAC) system, for example.

In at least several of the above embodiments related to TSA-modules, the adsorption and the regeneration temperatures can be different, in some cases by a substantial amount. In some embodiments, adsorption is performed at lower temperatures so as to lower the kinetic energy of the gas mixture, the gas to be adsorbed and/or the adsorbents to effectively adsorb the gas by the sorbent material. Adsorption at higher temperatures may increase the system kinetic energy and thus decrease the adsorption efficiency. Regeneration, on the other hand, can be performed at relatively high temperatures so as to elevate the system kinetic energy and effectively remove the adsorbed gas from the sorbent. For example, in some embodiments, adsorptions can be performed at temperatures in the range from about 10° C. to about 30° C., while regeneration may be performed at temperatures in the range from about 30° C. to about 120° C. In some embodiments, in particular when the adsorption-regeneration cycle is at least substantially continuous, the time it takes to transition between the adsorption and the regeneration temperatures may decrease the scrubbing efficiency of the multistage scrubber. Accordingly, it would advantageous to at least reduce if not eliminate the temperature transition time for switching between two different temperatures for adsorption and regeneration. In such embodiments, TSA cycles can be replaced with CSA cycles performed at a predetermined temperature.

In some embodiments, the adsorption and regeneration cycles of a module of the multistage scrubber can be performed during a concentration swing adsorption (CSA) cycle at predetermined working temperatures that are at least substantially equal to each other. In some embodiments, the predetermined working temperatures of the adsorption and regeneration cycles may in fact be identical to each other. In some embodiments, the similar predetermined working temperatures of the adsorption and regeneration cycles may be within a range of about 10° C. or less, about 8° C. or less, about 6° C. or less, about 4° C. or less, about 2° C. or less, including values and subranges therebetween. In some embodiments, this predetermined working temperature can be determined for performing both the adsorption and the regeneration at a sufficient efficiency while continuously transitioning from the adsorption to the regeneration cycle and vice versa during the CSA. In other words, this predetermined working temperature allows maintaining a stable transition state such that the gas to be scrubbed from the gas mixture adducts to the sorbent during adsorption, yet readily abducts or is released from the sorbent during regeneration, where both the adsorption and regeneration are efficiently performed at a similar temperature (i.e., the predetermined working temperature).

In some embodiments, efficient adsorption may be a measure of the amount of gas (e.g. CO₂) adsorbed per amount of sorbent and likewise, efficient regeneration may be measured by the amount of gas removed per amount of sorbent. In a non-limiting example, sufficient efficient adsorption may be where the adsorbed gas (e.g., CO₂) comprises about 0.1% or more, about 1% or more, about 2% or more or anywhere between about 2% and about 50% of the sorbent weight. For example, 15% adsorption efficiency means that 150 grams of CO₂ is adsorbed by one kilogram of pre-adsorbed sorbent. In a non-limiting example, sufficient efficient regeneration may be when at least 60% or more of the adsorbed gas (e.g., CO₂) is removed from the sorbent.

A non-limiting example for CSA adsorption and regeneration at the predetermined working temperature comprises removal of 10% (=100,000 ppm) of CO₂ from a gas mixture comprising an air stream, during continuous or substantially continuous (i.e., without waiting for the treatment module temperature to change) adsorption and regeneration cycles of 2 minutes each. In such embodiments, the predetermined working temperature was found to be 55C°.

In some embodiments, the predetermined working temperature may be determined based on, inter alia, the gas concentration level, the chemical properties of the gas and/or gas mixture, the gas mixture flow rate, the chemical properties of the sorbent (e.g. type of amine-based compound and/or type of solid support) and the amount of sorbent in the treatment modules. It is noted that in some embodiments, the CSA is performed at a relatively high gas concentration level, such as at least 1% or more.

In some embodiments, following the CSA in one or more stages, a final stage or a number of stages may be performed by a temperature swing adsorption (TSA) cycle, wherein the working temperature may be more than 10° C. between the adsorption temperature and the regeneration temperature.

Additional embodiments of the current disclosure include a method for reducing a concentration of a first gas entrained in a gas mixture, comprising: providing a bed of sorbent configured for use in an adsorption-regeneration swing cycle, wherein: during an adsorption phase of the adsorption-regeneration swing cycle, a gas mixture flows over and/or through the sorbent bed to adsorb a first gas such that a concentration of the first gas in the mixture is reduced, during a regeneration phase of the adsorption-regeneration swing cycle, a stream of regeneration gas is flowed over and/or through the sorbent bed such that at least a portion of the adsorbed first gas is released from the sorbent bed, and a difference between an adsorption temperature of the sorbent bed during the adsorption phase and a regeneration temperature of the sorbent bed during the regeneration phase is below a threshold temperature differential. In some embodiments, the method of claim 1, wherein threshold temperature differential is less than about 20° C., less than about 10° C., less than about 5° C., less than about 2° C., including values and ranges therebetween.

In some embodiments, the threshold temperature differential is about 2° C., and both the adsorption temperature and the regeneration temperature are higher than about 50° C. In some embodiments, both the adsorption temperature and the regeneration temperature exceed a pre-adsorption temperature of the gas mixture by at least about 5° C., about 10° C., about 15° C., about 20° C., including values therebetween. In some embodiments, the period of the adsorption-regeneration swing cycle is less than about 20 minutes, about 10 minutes, 5 minutes, 2 minutes, about 30 seconds, including values and subranges therebetween.

The following examples illustrate some embodiments of performing the disclosure and are not meant to be limiting in any manner:

### Example 1

Adsorption and regeneration cycles were performed in three stages using three sorbent packed columns connected in series. The first and second column length was 20 cm and the diameter was one cm and the third column length was 7 cm and the diameter was one cm. The first column housed about 140 grams of sorbent with an average granule surface area of 5 mesh. The second column housed about 120 grams of sorbent with an average granule surface area of 20 mesh. The third column housed about 97 grams of sorbent with an average granule surface area of 40 mesh. The sorbent contained granules formed of a solid support, supporting an amine-based compound.

The static pressure of the columns was set at 2 bars.

The first and second columns were heated by the heating liquid comprising water placed in the column jacket to 75° C. and 65° C., respectively. The third column was maintained at 25° C. The adsorption and regeneration cycles were performed for 3 minutes each.

The first and second stages were performed by CSA and the third final stage by TSA.

During the adsorption cycle, air comprising a CO₂ concentration of 20% (=200,000 ppm) flowed at a flow rate of 5 liters per minute (lpm) through the first column and the treated air exiting the first column was measured and found to contain a CO₂ concentration of 10% (=100,000 ppm). Following adsorption within the second column the treated air exiting the second column was measured and found to contain a CO₂ concentration of 0.2% (=2,000 ppm). Following adsorption within the third column the treated air exiting the third column was measured and found to contain a CO₂ concentration of 0.0005 (=5 ppm).

Regeneration and of the first and second columns was performed by concentration swing using pure nitrogen (at a concentration of 99.99%) as the purge gas.

During regeneration the adsorption temperate of the first column and the second column was maintained at 75° C. and 65° C., respectively. The regeneration of the third column was performed by temperature swing by elevating the temperature of the column from 25° C. to 65° C.

### Example 2

Adsorption and regeneration cycles were performed in three stages. The first stage was performed by a first column connected in series to a second and third column. The second and third columns performed the second stage and were connected therebetween in parallel. The third stage was performed by parallely connected fourth, fifth and sixth columns connected to the second stage columns in series.

Each of the first to sixth sorbent packed columns was of a column length of 20 cm and a diameter of one cm housing about 100 grams of sorbent. The first column of the first stage contained a sorbent with an average granule surface area of 10 mesh. The second and third columns of the second stage contained a sorbent with an average granule surface area of 30 mesh. The fourth, fifth and sixth columns of the third stage contained a sorbent with an average granule surface area of 40 mesh. The sorbent contained granules supporting an amine-based compound.

The first and second stages were performed by CSA and the third final stage by TSA.

The static pressure of the columns was set at 1.5 bars.

The heated columns were heated by the heating liquid comprising water placed in the column jacket. The first column of the first stage was heated to 55° C. The second and third columns of the second stage were both heated to 45° C. The fourth, fifth and sixth columns of the third stage were maintained at room temperature of 25° C. The adsorption and regeneration cycles were performed for 2 minutes each.

During the adsorption cycle, air comprising a CO₂ concentration of 20% (=200,000 ppm) flowed at a flow rate of 5 liters per minute (lpm) through the first column at the first stage and the treated air exiting the first column was measured and found to contain a CO₂ concentration of 10% (=100,000 ppm). Following adsorption within the second and third columns of the second stage the treated air exiting the second column was measured and found to contain a CO₂ concentration of 0.1% (=1,000 ppm). Following adsorption within the fourth, fifth and sixth columns of the third stage the treated air exiting the third and final stage was measured and found to contain a CO₂ concentration of 0.0001% (=1 ppm).

Regeneration of the first and second stage columns was performed by concentration swing using pure nitrogen (at a concentration of 99.99%) as the purge gas. The adsorption and regeneration cycles during the second stage was performed intermittently by the parallely connected columns. E.g. while the second column was adsorbing the third column was regenerated.

During regeneration the adsorption temperate of the first stage column and the second stage columns was maintained at 55° C. and 45° C., respectively. The regeneration of the third stage columns was performed by temperature swing by elevating the temperature of the column from 25° C. to 65° C. The adsorption and regeneration cycles during the third stage was performed intermittently by the parallely connected columns while the remaining column cooled down from the elevated temperature. E.g. while the fourth column was adsorbing, the fifth column was regenerated and the sixth column was cooled from the regeneration temperature of 65° C. down to the adsorption temperature of 25° C.

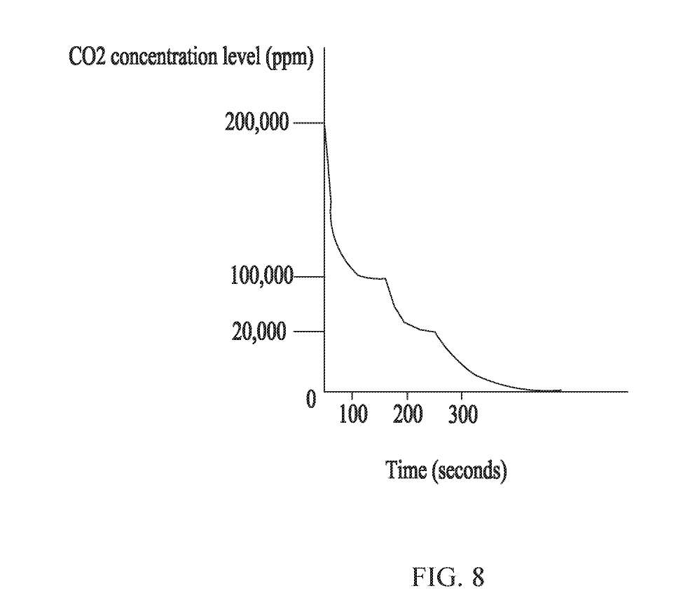

A schematic illustration of the system is shown in FIG. 4 and the CO₂ concentration level at the outlet of the system is shown Vs. the adsorption cycle time on the graph of FIG. 8.

### Example 3

Adsorption and regeneration cycles were performed in three stages using three sorbent packed columns connected in series. All of the columns were formed with a length of 10 cm and a diameter of one cm and housed 97 grams of sorbent with an average granule surface area of 20 mesh. The sorbent contained granules supporting an amine-based compound. The first column contained silica granules supporting an amine-based compound comprising branched triethylenetetramine (TETA). The second column contained silica granules supporting an amine-based compound comprising branched tetraethylenePENTAmine (TEPA). The third column contained silica granules supporting an amine-based compound comprising linear pentaethylenehexamine (PEHA).

The first and second stages were performed by CSA and the third final stage by TSA.

The static pressure of the columns was set at 2 bars.

The first and second columns were heated by the heating liquid comprising water placed in the column jacket to 55° C. and 50° C., respectively. The third column of the third stage was maintained at room temperature of 25° C.

The adsorption and regeneration cycles were performed for 2 minutes each.

During the adsorption cycle air comprising a CO₂ concentration of 20% (=200,000 ppm) flowed at a flow rate of 5 liters per minute (lpm) through the first column and the treated air exiting the first column was measured and found to contain a CO₂ concentration of 12% (=120,000 ppm). Following adsorption within the second column the treated air exiting the second column was measured and found to contain a CO₂ concentration of 2% (=20,000 ppm). Following adsorption within the third column the treated air exiting the third column was measured and found to contain a CO₂ concentration of 0.0005 (=5 ppm).

Regeneration of the first and second columns was performed by concentration swing using pure nitrogen (at a concentration of 99.99%) as the purge gas.

During regeneration the adsorption temperate of the first column and the second column was maintained at 55° C. and 50° C., respectively. The regeneration of the third column was performed by temperature swing by elevating the temperature of the column from 25° C. to 80° C.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be an example and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure. Some embodiments may be distinguishable from the prior art for specifically lacking one or more features/elements/functionality (i.e., claims directed to such embodiments may include negative limitations).

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A multi-stage system for reducing a concentration of at least a first gas entrained in a gas mixture, the system comprising a plurality of staged treatment systems (STSs) including at least one concentration swing adsorption (CSA)-based stage treatment system and at least one temperature swing adsorption (TSA)-based stage treatment system, wherein:
each STS comprises one or more treatment assemblies each including a regenerable adsorption material;
the STSs are configured to successively treat a gas mixture having at least a first gas entrained therein, one after the other, such that, after the gas mixture is treated by the CSA-based STS it is subsequently received and treated by the TSA-based STS,
the regenerable adsorption material for the CSA-based STS is configured to regenerate by a first regeneration airflow via a CSA cycle,
the regenerable adsorption material for the TSA-based STS is configured to regenerate by a second regeneration airflow via a TSA cycle,
and wherein:
a concentration of the first gas in the gas mixture prior to treatment by any one of the plurality of STS is greater than about 10%,
a concentration of the first gas in the gas mixture prior to treatment by any one of the plurality of STS is greater than about 20%,
a concentration of the first gas entrained in the gas mixture upon exiting the multi-stage system is less than about 50 parts per million (ppm),
a concentration of the first gas entrained in the gas mixture upon exiting the multi-stage system is less than about 10 parts per million (ppm),
any one of the first or second regeneration airflow is exhausted by a fuel cell system and the first gas entrained in the gas mixture is CO₂,
or
the gas mixture is to enter a fuel cell system following treatment by any of the plurality of STS, the first gas entrained in the gas mixture is CO₂, and one or both of the first and second regeneration airflows include nitrogen exhausted from the fuel cell system.

2. The system of claim 1, wherein the one or more treatment assemblies include at least two treatment assemblies.

3. The system of claim 1, further comprising a primary inlet manifold configured to receive the gas mixture into the system.

4. The system of claim 1, further comprising a primary outlet manifold configured to release the gas mixture after treatment by all of the plurality of STSs.

5. The system of claim 1, wherein one or more of the plurality of STS include between about 2-10 treatment assemblies.

6. The system of claim 1, wherein each STS includes at least two treatment assemblies connected in parallel.

7. The system of claim 1, wherein each STS includes at least two treatment assemblies connected in parallel, one of the at least two treatment assemblies configured to be in a regeneration phase or an adsorption phase when the other treatment assembly is in an adsorption phase or a regeneration phase, respectively.

8. The system of claim 1, wherein regeneration of the regenerable adsorption material for the CSA-based STS is performed at a temperature that is no greater than about 10° C. above an adsorption temperature during adsorption of the first gas by the regenerable adsorption material for the CSA-based STS.

9. The system of claim 1, wherein regeneration of the regenerable adsorption material for the CSA-based STS is performed at a temperature that is no greater than about 20° C. above an adsorption temperature during adsorption of the first gas by the regenerable adsorption material for the CSA-based STS.

10. The system of claim 1, wherein regeneration of the regenerable adsorption material for the TSA-based STS is performed at a temperature that is at least about 10° C. above an adsorption temperature during adsorption of the first gas by the regenerable adsorption material for the TSA-based STS.

11. The system of claim 1, wherein regeneration of the regenerable adsorption material for the TSA-based STS is performed at a temperature that is at least about 20° C. above an adsorption temperature during adsorption of the first gas by the regenerable adsorption material for the TSA-based STS.

12. The system of claim 1, wherein the first gas entrained in the gas mixture is CO₂.

13. The system of claim 1, wherein the first gas entrained in the gas mixture is one of ammonia, hydrogen, water, carbon monoxide and urea.

14. The system of claim 1, wherein a concentration of the first gas in the gas mixture prior to treatment by any one of the plurality of STS is greater than about 5%.

15. (canceled)

16. (canceled)

17. The system of claim 1, wherein a first STS of the plurality of STS to treat the gas mixture removes between about 50% to about 90% of a concentration of the first gas entrained in the gas mixture.

18. The system of claim 1, wherein a first STS of the plurality of STS to treat the gas mixture removes between about 50% to about 99% of a concentration of the first gas entrained in the gas mixture.

19. (canceled)

20. (canceled)

21. The system of claim 1, wherein one or both of the regenerable adsorption material for the CSA-based STS and the regenerable adsorption material for the TSA-stage treatment system are solid-supported amine.

22. The system of claim 1, wherein the TSA-based STS is configured to treat the gas mixture last prior to the gas mixture exiting the system without being treated any further by any other treatment assembly of the plurality of STS.

23. The system of claim 1, wherein one or both of the first and second regeneration airflows include atmospheric air.

24. (canceled)

25. The system of claim 1, wherein one or both of the regenerable adsorption material for the CSA-based STS and the regenerable adsorption material for the TSA-based STS include granules with a surface area from about 4 mesh to about 140 mesh.

26. (canceled)

27. The system of claim 1, wherein the treatment assembly comprises a plurality of stacked regenerable adsorption materials forming a STS, wherein at least a first stack comprises a CSA-stage treatment system or a TSA-stage treatment system.

28. (canceled)
